(19) United States
(12) Patent Application Publication
(10) Pub. No.: US 2007/0246013 A1
(43) Pub. Date: Oct. 25, 2007

(54) Method of operating an internal combustion engine

(76) Inventors: Rudiger Herweg, Esslingen (DE); Matthias Pfau, Ludwigsburg (DE); Mayk Stelter, Stuttgart (DE)

Correspondence Address: KLAUS J. BACH & ASSOCIATES;PATENTS AND TRADEMARKS, 4407 TWIN OAKS DRIVE, MURRYSVILLE, PA, 15668, US

(21) Appl. No.: 11/796,796

(22) Filed: Apr. 27, 2007

Related U.S. Application Data
(63) Continuation-in-part of application No. PCT/EP05/11244, filed on Oct. 19, 2005.

(30) Foreign Application Priority Data
Oct. 30, 2005 (DE) 10 2004 052 742.3

(51) Int. Cl. F02P 5/00; F02M 7/00; F02M 25/07; G06F 17/00; F02B 47/08

(52) U.S. Cl. 123/406.22; 123/435; 123/568.14; 701/103

(57) ABSTRACT

In a method for operating an internal combustion engine including a control device and having a cylinder including a combustion chamber formed in the cylinder between a cylinder head and a piston and in which a first combustion chamber pressure (p₁) is measured before the start of the combustion, a second combustion chamber pressure (p₂) is measured after the end of the combustion and a third combustion chamber pressure (p₃) is measured during the combustion, and a combustion center position of the respective combustion process is determined therefrom by the control device and the engine operating conditions are adjusted so as to bring the combustion center position to an optimum position for minimizing fuel consumption and exhaust emission.

This is a Continuation-In-Part Application of pending International Patent Application PCT/EP2005/011244 filed Oct. 19, 2005 and claiming the priority of German Patent Application 10 2004 052 742.3 filed Oct. 30, 2005.

### BACKGROUND OF THE INVENTION

The invention relates to method of operating an internal combustion engine, in particular an auto-ignition internal combustion engine, including a combustion chamber in which the pressure is measured during the combustion cycle.

An aim of the development of new internal combustion engines is to minimize the formation of exhaust gas emissions and to obtain an increase in efficiency. In internal combustion engines, the combustion process of the air/fuel mixture in the combustion chamber, the efficiency of the internal combustion engine and the pollutant emissions and also the fuel consumption are decisively influenced by the combustion position or by the center of the combustion position. In auto-ignition internal combustion engines, the combustion noise is likewise influenced by the center of the combustion position. It is therefore necessary to control the combustion behavior in such a way as to ensure an optimum combustion position throughout the entire operation of the internal combustion engine in order in particular to minimize the resulting noise and pollutant emissions.

The position of the combustion or the center of the combustion position describes, on the basis of the first law of thermodynamics, that time or piston position during the combustion at which 50% of the introduced fuel energy has been converted to heat. The center of the combustion is conventionally denoted by the associated crank angle position, of the piston at which 50% of the fuel quantity involved in the combustion has been converted to heat. In order to be able to precisely control the combustion position of the 50% mass conversion point, by regulating the combustion during operation of an internal combustion engine, it is necessary to determine a current actual value of the combustion position during engine operation.

DE 198 04 988 C1 discloses a method for operating an internal combustion engine with direct injection and combustion of homogeneous, lean air/fuel mixtures with compression ignition, by means of which method, in order to measure and detect undesired combustion processes, the position and the process of a combustion are measured in real-time by means of actual engine values such as the body-borne noise of the internal combustion engine, the ion flow in the combustion chamber or the non-congruency of the crankshaft. The measured measurement signals regarding the process of the combustion are compared with nominal parameters which are stored in characteristic diagrams. The regulating logic which is provided for this purpose should detect the features of desired and undesired combustion regions by means of pattern recognition by adaptive regulators and, in order to adjust to the required nominal values, vary the necessary engine parameters using actual engine values.

WO 03/085244 A1 discloses a method for operating an internal combustion engine with compression ignition, in which method a regulating operation of the combustion is provided during which the position of a 50% mass conversion point of the current combustion is incorporated as a regulating variable. In order to determine the position of the 50% mass conversion point in the combustion process, an ion current signal is measured by means of an ion current probe arranged in the combustion chamber, and an actual value of the position of the 50% mass conversion point of the current combustion is determined from this by integrating said ion current signal. The actual value is then compared with a value which is stored in a control unit. If required, the process of the combustion is varied in a subsequent working cycle by means of an adaptation of operating parameters.

Furthermore, a signal of the pressure profile during the combustion is often recorded and incorporated in order to determine the combustion position. For this purpose, it is necessary for the cylinder pressure to be measured continuously for the entire combustion process within a combustion cycle. That is to say that a continuous pressure measurement is carried out during the combustion at a relatively high resolution, for example once per degree crank angle. The combustion position can subsequently be determined by integrating the recorded cylinder pressure profile. A high-resolution measurement, however, entails a high demand for computing and memory capacity for the engine control units, which leads to slow combustion regulation and therefore to an unfavorable combustion process. Optimum operating behavior with high efficiency is therefore not always ensured.

It is the object of the present invention to determine a current combustion position in such a way as to reduce the computing expenditure and required memory capacity for an engine controller of the internal combustion engine.

### SUMMARY OF THE INVENTION

In a method for operating an internal combustion engine having a control device and also having a cylinder including a combustion chamber formed in the cylinder between a cylinder head and a piston wherein, wherein a first combustion chamber pressure (p₁) is measured before the start of the combustion, a second combustion chamber pressure (p₂) is measured after the end of the combustion and a third combustion chamber pressure (p₃) is measured during the combustion, and a combustion center position of the respective combustion cycle is determined therefrom by means of the control device and the engine operating conditions are adjusted so as to bring the combustion center position to an optimum position for minimizing fuel consumption and exhaust emissions.

A current combustion center position is thereby determined at points during the operation of the internal combustion engine by means of a triple or multiple discontinuous pressure measurement in the combustion chamber. Only a minimum computing capacity is therefore required in the control device as a result of the reduced and limited measurement, in relation to conventional methods, of the combustion chamber pressure for the purpose of determining the combustion position. It is possible in this way, in order to obtain optimum combustion efficiency, for the combustion to be regulated efficiently by means of the corresponding operating parameters.

In a refinement of the invention, the first combustion chamber pressure is measured during a compression stroke of the piston, with the second combustion chamber pressure preferably being measured during an expansion stroke of the piston. Two extensive ranges are therefore available for pressure measurement, which permit an expedient variation, so that it is possible for the measuring times to be continuously adapted within the relevant ranges as a function of the momentary load point.

In a further embodiment of the invention, in order to determine the combustion position in the respective combustion cycle, a first reference pressure, a second reference pressure and a third reference pressure are formed from the first, the second and the third combustion chamber pressure.

In a further embodiment, it is provided according to the invention that, in order to determine the combustion position in the respective combustion cycle, a first pressure difference is formed from the first and the second reference pressure. The computing capacity of the control device need thereby carry out only a simple formula which is fast and simple to calculate.

In still a further embodiment of the invention, the third combustion chamber pressure is measured at a point in time when a nominal value of the combustion position is located, with in particular a second pressure difference being formed from the third and the first reference pressure. This requires one further pressure measurement in a defined range during the combustion. A measurement of the combustion chamber pressure in a large range is thereby avoided. According to the invention, the total number of pressure measurements per combustion cycle is restricted to three points. Nevertheless, despite the low number of combustion chamber pressure measurements, a characteristic dependency is determined, as a function of the third measurement time during the combustion, between the 50% conversion point and a conversion rate of the fuel at the respective measurement time.

In a further embodiment of the invention, a current actual value of the combustion position is determined from a ratio of second pressure difference to first pressure difference. With the quotient which is formed, a deviation from a nominal value of the combustion position is determined, which permits a fast correction during operation. Simple and fast determination of the combustion position is thereby possible.

In a further embodiment of the invention, a fourth combustion chamber pressure is recorded during the compression stroke at an interval of from 30°CA to 50°CA, preferably 40°CA before the measurement of the first combustion chamber pressure. With the two pressure values measured in the compression phase, in particular using relative pressure pickups, for example piezoelectric pressure pick-ups, a deviation from actual pressure conditions is determined.

In a further embodiment of the invention, a thermodynamic zero point correction takes place before the determination of the combustion position. It is made possible to carry out a thermodynamic zero point correction for determining a possible deviation in particular with the fourth and the first pressure value. A thermodynamic zero point correction is preferably carried out in connection with piezoelectric pressure pick-ups, since they determine a dynamic pressure change. A possible deviation of the measurement signal from the actual value is then determined on the basis of the thermodynamic zero point correction. All four measured pressure values are subsequently corrected by one correction magnitude, so that a precise determination of the combustion position can take place thereafter.

According to a further embodiment of the invention, fuel injection times, an exhaust gas quantity which is retained in the combustion chamber and/or an ignition time of an air/fuel mixture formed in the combustion chamber are adapted as a function of the determined actual value of the combustion position in such a way as to provide the nominal value of the combustion position. The optimum combustion position or the desired center position of the combustion can thereby be set efficiently for the internal combustion engine, so that, at the respective operating point, the optimum combustion position is reached within a small number of combustion cycles.

Further features and feature combinations are apparent from the description. Exemplary embodiments of the invention will be described in a simplified form in the following description on the basis of the accompanying drawings:

### BRIEF DESCRIPTION OF THE DRAWINGS

FIG. 1 shows a schematic diagram of a cylinder pressure profile of an internal combustion engine during a working cycle, plotted over the stroke volume,

FIG. 2 shows a schematic diagram of a conversion rate of the internal combustion engine as per FIG. 1 during a working cycle, plotted over the crank angle,

FIG. 3 shows three different illustrations of a determined combustion position of the internal combustion engine as per FIG. 1 as a function of a measuring time,

FIG. 4 shows a further schematic diagram of a cylinder pressure profile during a working cycle, plotted over the stroke volume, and

FIG. 5 is a schematic illustration of the dependency between a determined pressure difference and an indicated mean effective pressure of the internal combustion engine as per FIG. 1.

### DESCRIPTION OF VARIOUS EMBODIMENTS

An exemplary internal combustion engine according to the invention with direct injection comprises, for example, four cylinders in which in each case one piston is guided. In each cylinder, a combustion chamber of the internal combustion engine is upwardly closed off by a cylinder head, with the piston delimiting the combustion chamber in the downward direction. The internal combustion engine comprises, per combustion chamber, at least one intake valve, at least one exhaust valve, a fuel injector and preferably an ignition source. A pressure pick-up or a pressure sensor for measuring the cylinder pressure is provided in the combustion chamber, it being alternatively possible for the pressure sensor to be integrated into the ignition source.

The internal combustion engine preferably operates on the 4-stroke principle, with it likewise being possible within the context of the invention for said internal combustion engine to be operated according to the 2-stroke principle. The combustion air and the exhaust gases which are generated are respectively introduced into the combustion chamber and discharged out of the combustion chamber via the intake and respectively exhaust valves. The intake and exhaust valves are opened and closed by an actuating device, with an engine control device controlling the opening and closing times of the intake and exhaust valves corresponding to the momentary operating point.

In a 4-stroke method, one stroke corresponds to a full piston stroke. FIG. 1 illustrates, in a detail, the profile of a combustion chamber pressure during a working cycle of the internal combustion engine according to the invention. The working cycle of the internal combustion engine, which is composed of four strokes, corresponds to one combustion cycle, wherein a combustion cycle begins with a first intake stroke in which the piston moves in a downward movement to the bottom dead center. In the intake stroke, the combustion chamber is supplied with combustion air, with a defined quantity of exhaust gas preferably being retained in the combustion chamber in the exhaust stroke of the preceding working cycle.

During the intake stroke, an air/fuel mixture is formed in the combustion chamber as a result of the introduction of fuel into the combustion chamber, which air/fuel mixture is compressed in a subsequent compression stroke. During the compression stroke, the piston moves upwardly from the bottom dead center to the ignition top dead center ITDC, wherein for forming the mixture, a main fuel quantity is preferably introduced into the combustion chamber during the intake stroke. The air/fuel mixture or main mixture which is formed is self-ignited in the region of the ignition top dead center ITDC as a result of a high compression or alternatively, the mixture ignited externally by means of the ignition source, which is preferably embodied as a spark plug, in a load-dependent manner during engine warm-up or during high load engine operation. During combustion of the air/fuel mixture, the piston moves downward toward the bottom dead center. In the subsequent exhaust stroke, the piston travels in an upward direction to a top gas exchange dead center and pushes the exhaust gases out of the combustion chamber. Within the context of the invention, an exhaust valve is opened during the exhaust stroke so that the exhaust gases are discharged from the combustion chamber, with a defined quantity of exhaust gas being retained in the combustion chamber by means of an early closing of the exhaust valve. During the exhaust stroke, it is possible in a load-point-dependent manner for an additional fuel quantity to be supplied to the combustion chamber in such a way that an intermediate mixture of fuel, exhaust gas and, if appropriate, air is formed, which intermediate mixture is then further compressed and partially converted in the region of top gas exchange dead center. The temperature of the main mixture can be influenced, and therefore an ignition time of the main mixture can be varied, by means of the conversion of the intermediate mixture.

It is possible by means of the pressure sensor for a pressure profile in the combustion chamber during a working cycle to be measured and transmitted to an engine control device. The momentary combustion position or an actual value of the combustion position can be determined from the measured pressure profile. The combustion position varies in relation to the crank angle in the event of a change of the combustion profile. In order to optimize the computing expenditure and the memory capacity in the control device, the invention proposes to measure the cylinder pressure at three points. Three individual combustion chamber pressure values are therefore recorded and transmitted to the control device.

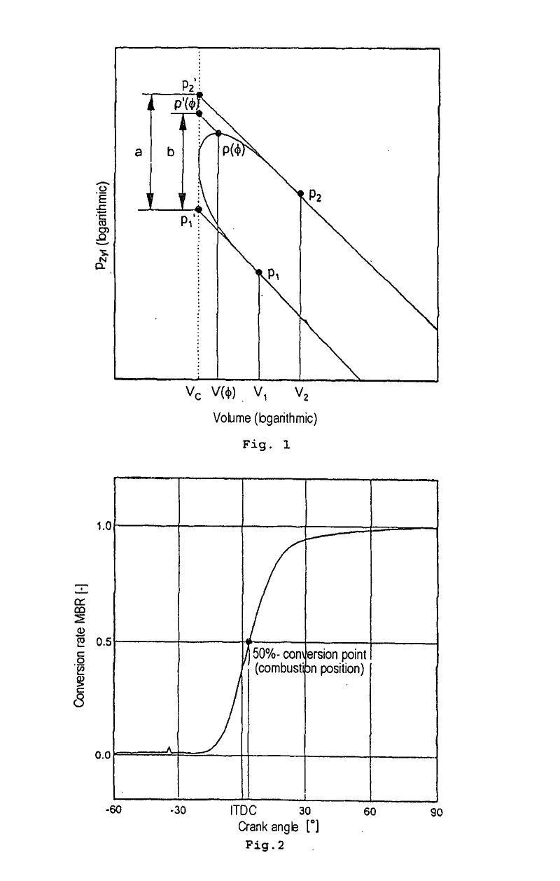

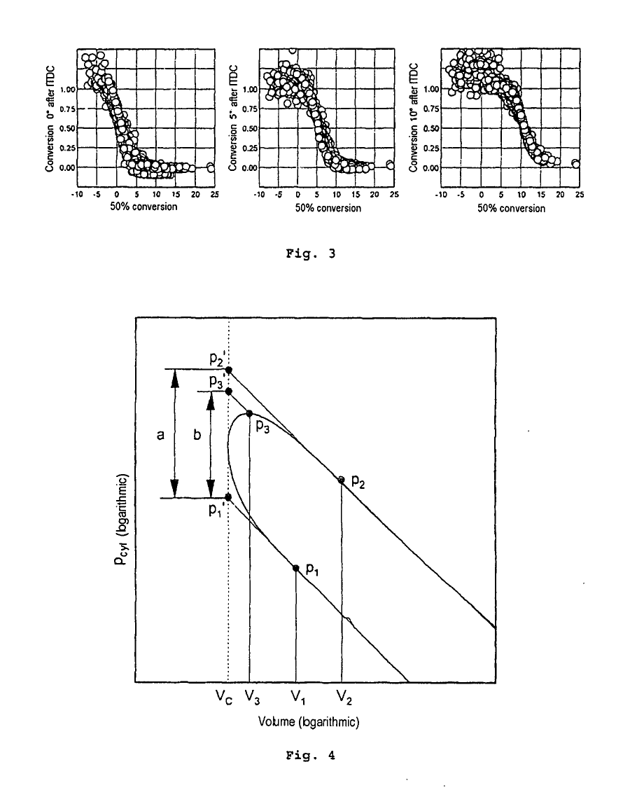

The following text explains how a momentary combustion position is determined. The following basic thermodynamic equations form the basis for the simple determination of the combustion profile in an internal combustion engine. The equations are illustrated graphically in FIG. 1 and FIG. 2. At each cylinder pressure pᵢ, a reference pressure pᵢ′ is calculated as follows:

$${p}_{i}^{′} = {p}_{i} \cdot {( \frac{{V}_{i}}{{V}_{C}} )}^{κ}$$

A fuel conversion rate at a defined crank angle position is denoted by MBR(Φ) and is calculated as follows:

$$MBR ( ϕ ) = \frac{b ( ϕ )}{a}$$

In addition, V_{C} corresponds to the compression volume of the internal combustion engine, with Vᵢ corresponding to the volume at the time of the pressure measurement. The symbol K corresponds to the isentropic exponent and is dependent on the thermodynamic properties of the working medium or of the air/fuel mixture. The value a corresponds to a pressure difference which can be calculated from the reference pressure in the compression and the reference pressure in the expansion, as follows:
a=Δp₁₂=p′₂−p′₁

Here, the value b is calculated from the difference between the reference pressure at the crank angle position Φ during the combustion and the reference pressure in the compression before the start of the combustion, as follows:
b(φ)=Δp=p′(φ)−p′₁

As per FIG. 1 and FIG. 4, the pressure p₁ describes the measured cylinder pressure at a time in the compression phase at which no fuel has yet been converted. The pressure p₂, in contrast, describes the measured cylinder pressure at a time in the expansion phase at which the entire fuel quantity has been converted.

In order to carry out a conventional calculation of the combustion position, it is necessary to measure the cylinder pressure profile at a relatively high resolution, for example at each crank angle position, for the entire combustion profile. The determination of the 50% conversion point can subsequently be carried out by integrating the fuel conversion rate MBR(Φ) over the entire crank angle profile as per the illustration in FIG. 2. A high-resolution measurement, however, is disadvantageous for the operation of the internal combustion engine and in particular for the engine control device, since the required computing capacity adversely affects the control of the combustion during operation.

In contrast, in order to set an optimum combustion position, the present invention provides that a deviation of a current value of the combustion position from a nominal value is determined. For this purpose, a first combustion chamber pressure p₁ is measured during the compression stroke before the start of the combustion, a second combustion chamber pressure p₂ is measured during the expansion stroke after the end of the combustion, and a third combustion chamber pressure is measured during the combustion or during the fuel conversion. The total number of measurements of the pressure profile per cycle is thereby restricted to three values. Here, at the three measured combustion chamber pressures, the associated reference pressures are formed as follows:

$${p}_{i}^{′} = {p}_{i} \cdot {( \frac{{V}_{i}}{{V}_{C}} )}^{κ}$$

A pressure difference Δp₁₂ is calculated from the first and the second reference combustion chamber pressure. As per FIG. 3, a characteristic dependency, as a function of the third combustion chamber pressure, between the 50% conversion point and the conversion rate MBR at the measuring point of the third pressure is then utilized in order to determine the 50% conversion point from the conversion rate at the measuring point. Here, a corresponding conversion rate at the respective measuring time or crank angle position is calculated, as per FIG. 4, as follows:

$${MBR}_{measuring\_angle} = \frac{{p}_{3}^{′} - {p}_{1}^{′}}{Δ p}$$

The optimum combustion position for the respective internal combustion engine can for example be determined on the test stand. Said nominal value is then stored in the engine control device for the respective internal combustion engine.

According to the invention, the measuring time for the third combustion chamber pressure p₃ is set to the nominal value of the combustion position or placed at the crank angle position of the nominal value. The combustion control according to the invention provides that, in determining a deviation from the nominal value, a correction of the combustion position is carried out. If the value for MBR_{measuring}_{_{—}}_{angle} is greater than 0.5, then the actual combustion position is too early and the combustion control can correct the current combustion position in the next combustion cycle by means of the associated actuating variables. If the value for MBR_{measuring}_{_{—}}_{angle} is less than 0.5, then the combustion position can likewise be corrected by means of an inverse manipulation of the actuating variables. According to the invention, therefore, with the measurement of only three combustion chamber pressures, a deviation from the nominal value is determined quickly and a corresponding correction is accordingly initiated immediately. In this way, targeted and fast control of the internal combustion engine at the respective load point is carried out, so that the internal combustion engine is operated with a high degree of efficiency with a simultaneous reduction of the exhaust gas emissions.

According to a further exemplary embodiment of the invention, a fourth pressure value is recorded during the compression stroke. The fourth pressure value p₄ is preferably measured at an interval of from 30°CA to 50°CA, preferably 40°CA before the measurement of the first combustion chamber pressure p₁. Here, the fourth pressure measurement for measuring the fourth combustion chamber pressure p₄ takes place approximately 90°CA to 110°CA, preferably 100°CA before ignition top dead center ITDC, with the measurement of the first combustion chamber pressure p₁ being carried out 50°CA to 70°CA, preferably approximately 60°CA before ignition top dead center ITDC.

Deviations occur in the determined pressure values in particular when using relative pressure sensors, for example piezoelectric pressure sensors. In order to correct such deviations, the invention provides the implementation of a thermodynamic zero point correction. It is made possible with the fourth and the first pressure value to determine any occurring deviation on the basis of a thermodynamic zero point correction. It is thereby possible for all the measured pressure values to be corrected by one calculated correaction magnitude. A precise determination of the combustion position is obtained in this way.

The magnitude by which a pressure measurement deviates is calculated by means of the following isentropic relationship.

$$Δ {p}_{k} = \frac{{p}_{4} \cdot {V}_{4}^{κ} - {p}_{1} \cdot {V}_{1}^{κ}}{{V}_{1}^{κ} - {V}_{4}^{κ}}$$

$${p}_{1} = {p}_{1} + Δ {p}_{k}$$

$${p}_{2} = {p}_{2} + Δ {p}_{k}$$

$${p}_{3} = {p}_{3} + Δ {p}_{k}$$

Accordingly, all the pressure values are then corrected with the calculated correction magnitude Δpₖ before the determination of the combustion position.

According to the invention, it is possible, in particular for adjusting the center of combustion, to vary those engine parameters which correct the combustion profile and, therefore, the combustion position if required. A variation of the associated actuating variables or fuel injection parameters such as injection time, injection duration, retained exhaust gas quantity in the combustion chamber, start of the auto-ignition and/or injection timing can be carried out in such a way as to produce the best possible combustion position in the respective combustion process.

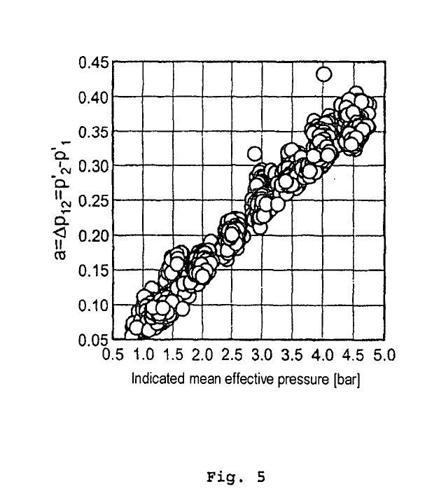

According to the invention, it is also possible by means of the measured cylinder pressure values to draw conclusions regarding the internal work of the respective cylinder. The indicated mean effective pressure pₘᵢ serves as a measure for this purpose. The linear correlation, which can be seen in FIG. 5, between the indicated mean effective pressure and the value a can be determined very precisely in particular when the charge exchange work remains approximately constant as a function of load.

What is claimed is:

1. A method of operating an internal combustion engine having a control device and having a cylinder with a combustion chamber formed in the cylinder between a cylinder head and a piston, said method comprising the steps of measuring, in the combustion chamber, a first combustion chamber pressure (p₁) before the start of combustion, measuring a second combustion chamber pressure (p₂) after the end of the combustion and measuring a third combustion chamber pressure (p₃) during the combustion, determining therefrom a combustion position of the respective combustion cycle, determining from the measured combustion pressures an actual combustion center position and adjusting the combustion conditions so that the actual center of combustion is moved to an optimum position for the particular operating state of the engine.

2. The method of operating an internal combustion engine as claimed in claim 1, wherein the first combustion chamber pressure (p₁) is measured during a compression stroke of the piston.

3. The method for operating an internal combustion engine as claimed in claim 1, wherein the second combustion chamber pressure (p₂) is measured during an expansion stroke of the piston.

4. The method for operating an internal combustion engine as claimed in claim 1, wherein, in order to determine the combustion position in the respective combustion cycle, a first reference pressure (p₁′), a second reference pressure (p₂′) and a third reference pressure (p₃′) are formed from the first, the second and the third combustion chamber pressure.

5. The method of operating an internal combustion engine as claimed in claim 1, wherein, in order to determine the combustion position in the respective combustion cycle, a first pressure difference (p₁′−p₂′) is formed from the first and the second reference pressure.

6. The method of operating an internal combustion engine as claimed in claim 1, wherein the third combustion chamber pressure (p₃) is measured at a time at which a nominal value of the combustion position and forming a second pressure difference (p₃′−p₁′) from the third and the first reference pressure values.

7. The method of operating an internal combustion engine as claimed in claim 6, wherein a momentary actual value of the combustion center position is determined from a ratio of the second pressure difference (p₃′−p₁′) to first pressure difference (p₁′−p₂′).

8. The method of operating an internal combustion engine as claimed in claim 7, wherein a fourth combustion chamber pressure (p₄) is recorded during the compression stroke at an interval of from 30°CA to 50°CA, preferably 40°CA, before the measurement of the first combustion chamber pressure (p₁).

9. The method of operating an internal combustion engine as claimed in claim 1, wherein a thermodynamic zero point correction is initiated before the determination of the combustion position.

10. The method of operating an internal combustion engine as claimed in 8, wherein the thermodynamic zero point correction is carried out incorporating the two pressure values (p₁; p₄) measured during the compression stroke.

11. The method of operating an internal combustion engine as claimed in claim 1, wherein at least one of fuel injection times, an exhaust gas quantity which is retained in the combustion chamber and an ignition time of the internal combustion engine are adapted as a function of the determined actual value of the combustion position in such a way as to determine the actual value of the center combustion position.

12. The method for operating an internal combustion engine as claimed in claim 5, wherein the first pressure difference is incorporated for determining at least one of an indicated mean cylinder pressure and an amount of internal work of a cylinder.

13. The method of operating an internal combustion engine as claimed in claim 1, wherein combustion in the internal combustion engine is initiated by means of a spark ignition during a starting mode and in high load and speed ranges, and by means of compression heat in low and medium load and speed ranges.
